(19) United States
(12) Patent Application Publication
(10) Pub. No.: US 2026/0280695 A1
(43) Pub. Date: Sep. 17, 2026

(54) HOLLOW CORE FIBER-BASED OPTICAL NETWORK LINE SYSTEM WITH MULTIPLE MULTIPLEXED OPTICAL SUPERVISORY CHANNELS

(71) Applicant: Microsoft Technology Licensing, LLC, Redmond, WA (US)

(72) Inventors: Matthew Artus TUGGLE, Seattle, WA (US); Yawei YIN, Redmond, WA (US); Shahab Bakhtiari GORAJOOBI, Southampton (GB); David John RICHARDSON, Southampton (GB)

(73) Assignee: Microsoft Technology Licensing, LLC, Redmond, WA (US)

(21) Appl. No.: 19/081,169

(22) Filed: Mar. 17, 2025

(51) Int. Cl. H04B 10/077; H04B 10/25

(52) U.S. Cl. CPC H04B 10/077; H04B 10/25

(57) ABSTRACT

Systems and methods are provided for implementing a hollow core fiber (“HCF”)-based optical network line system with multiple multiplexed optical supervisory channels. In examples, a first transponder of an optical line system (“OLS”) receives a first optical data signal at a first signal wavelength range, amplifies the first optical data signal into a second optical data signal, and generates two or more optical supervisory channel (“OSC”) signals at corresponding two or more OSC wavelengths separate from the first signal wavelength range. The first transponder injects the two or more OSC signals in the second optical data signal, and transmits the second optical data signal to a second transponder over an HCF communicatively coupling the two transponders over a fiber path distance. The two or more OSC signals are subsequently extracted from the second optical data signal, and analyzed to identify potential issues and/or measure optical properties in the OLS.

### BACKGROUND

In optical networking, in addition to carrying data traffic, optical fiber cables are also used to carry an optical supervisory channel that is used for monitoring the health of the optical networking system. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for a hollow core fiber-based optical network line system with multiple multiplexed optical supervisory channels (“OSCs”). In examples, the hollow core fiber-based optical network line system includes a first transponder located at a first location, a second transponder located at a second location that is geographically separated from the first location, and at least one hollow core fiber (“HCF”) cable communicatively coupling the second transponder to the first transponder over a fiber path distance. The first transponder transmits optical data traffic at a first signal wavelength range and transmits two or more OSC signals at corresponding two or more OSC wavelengths, the two or more OSC signals carrying data signals corresponding to diagnostic data associated with transmission of the optical data traffic. The at least one HCF cable transmits the optical data traffic and the two or more OSC signals between the first and second transponders. The hollow core fiber-based optical network line system further includes a plurality of OSC signal detectors disposed within at least one of the first transponder or the second transponder and a computing system. Each of the plurality of OSC signal detectors detects OSC signals at one of the corresponding two or more OSC wavelengths, while the computing system receives and analyzes OSC signals detected by two or more OSC signal detectors among the plurality of OSC signal detectors. The computing system identifies one or more potential issues in the optical network line system based on the analysis of the OSC signals, and measures one or more optical properties of the optical network line system.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing an HCF-based optical network line system with multiple multiplexed optical supervisory channels.

FIGS. 2A-2D depict cross-sectional views of various example configurations of HCFs when implementing an HCF-based optical network line system with multiple multiplexed optical supervisory channels.

FIGS. 3A-3D depict various example sets of OSC signal profiles corresponding to normal operations and to various potential issues in the optical network line system when implementing an HCF-based optical network line system with multiple multiplexed optical supervisory channels.

FIG. 4 depicts an example method for implementing an HCF-based optical network line system with multiple multiplexed optical supervisory channels.

FIG. 5 depicts a block diagram illustrating example physical components of a computing device with which aspects of the technology may be practiced.

### DETAILED DESCRIPTION OF CERTAIN EMBODIMENTS

As briefly discussed above, in addition to carrying data traffic, optical fiber cables are also used to carry an optical supervisory channel that is used for monitoring the health of the optical networking system. In conventional line systems, especially solid core fiber (“SCF”)-based optical network line systems, an OSC monitors whether there is a fault in a dark fiber (e.g., along a fiber path between two transponders). If there is no fault, the OSC signal power does not degrade over time. If there is a fault, however, such as a fiber break or a fiber bend, the OSC signal power will degrade either instantaneously or over time, respectively. In SCF-based optical network line systems, additional OSCs cannot be sustained because the increased signal power from another OSC light source can cause the optical network line system to experience optical nonlinearities, which adversely affects signals transmitted over the SCF (e.g., data signal transmissions as well as OSC signal transmissions). Where there is only a single OSC channel, a drop in OSC signal power could be due to a fiber break, a fiber bend, an imperfect connection, amongst other potential causes, without clarity on which potential cause is more likely to be the actual cause.

The present technology provides for an HCF-based optical network line system with multiple multiplexed optical supervisory channels. Because HCFs are capable of high optical power transmissions without incurring significant non-linearities, HCF-based optical network line systems can be configured to include multiple OSC transmitters whose OSC signals can be multiplexed with the optical data signals. The multiple OSC signals allow for detecting and identifying potential causes. In some examples, with multiple OSC channels, one could utilize the ratio of power drop between the various wavelengths to determine a source of the degradation, thereby significantly reducing the time to repair faults in the optical network line system.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

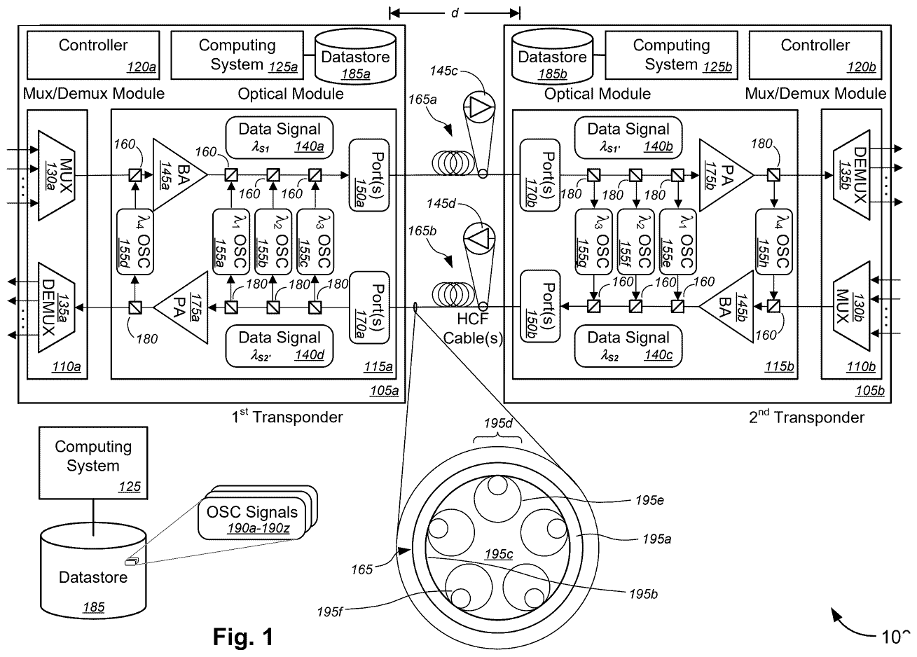

Turning to the embodiments as illustrated by the drawings, FIGS. 1-5 illustrate some of the features of methods, systems, and apparatuses for implementing an HCF-based optical network line system with multiple multiplexed optical supervisory channels, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing an HCF-based optical network line system with multiple multiplexed optical supervisory channels. System 100 includes a first transponder 105a and a second transponder 105b. The first transponder 105a includes a multiplexer/demultiplexer (“mux/demux”) module 110a, an optical module 115a, and a controller 120a and/or a computing system 125a. The mux/demux module 110a—which, in some cases, is embodied in a mux/demux card—includes a mux 130a and a demux 135a. The mux 130a receives multiple input data signals (denoted by the plurality of arrows that are shown entering the mux 130a) and outputs a multiplexed data signal 140a at a first signal wavelength (λ_{S1}) that is input into the optical module 115a. The optical module 115a—which, in some cases, is embodied in an optical card-includes transmitter components including a booster amplifier (“BA”) 145a, an output port(s) 150a, a plurality of OSC systems 155a-155d, and optical couplers 160. The BA 145a amplifies the data signal 140a. In some instances, the plurality of OSC systems 155a-155d include a corresponding plurality of OSC generators that generate OSC signals at a plurality of wavelengths λ₁-λ₄, respectively. Although four OSC systems 155a-155d are shown in FIG. 1, any suitable number of OSC systems 155a-155d may be used so long as two or more are used in accordance with the examples described herein. Also, although the OSC systems 155a-155d are depicted in particular relative positions within the first transponder 105a, the OSC systems can be located in any one or more portions of the first transponder 105a, including in the mux/demux module/card 110a, the optical module/card 115a, an amplifier module/card, before an optical amplifier(s), after an optical amplifier(s), and/or in another portion of the first transponder 105a. In examples, the plurality of OSC generators each includes either a fixed wavelength signal generator that outputs an optical signal at a single, fixed wavelength or a tunable wavelength signal generator that outputs an optical signal at a selected wavelength based on an input indicating the selected wavelength of the optical signal. In some cases, the fixed wavelength signal generator includes a fixed wavelength laser, while the tunable wavelength signal generator includes a tunable laser. Each of the optical couplers 160 injects one of the plurality of OSC signals (at one of the wavelengths λ₁−λ₄) into the data signal 140a (at signal wavelength λ_{S1}), and the resultant multiplexed signal is output from the output port(s) 150a. In some examples, a wavelength division multiplexing (“WDM”) system is used, in place of the optical couplers 160, to multiplex the data signal 140a (at the wavelength λ_{S1}) and the plurality of OSC signals (at the wavelengths λ₁-λ₄).

As shown in FIG. 1, the first transponder 105a and the second transponder 105b are communicatively coupled with each other via at least one HCF cable 165a and 165b (collectively, “HCF cable 165” or “HCF 165”) over a fiber path distance d. In some examples, the at least one HCF cable 165 communicatively coupling the first and second transponders 105a and 105b include two or more HCF cables that are spliced together to form a spliced-together HCF cable that achieves the fiber path distance (or fiber length) d, the ends of the spliced-together HCF cable being connected to each of the first transponder 105a and the second transponder 105b via connectors. The first transponder 105a and the second transponder 105b are geographically separated from each other. In examples, the distance d is one of about 15 km, about 20 km, about 25 km, about 30 km, about 40 km, about 50 km, about 60 km, about 70 km, about 80 km, about 90 km, about 100 km, about 110 km, about 120 km, about 130 km, about 140 km, about 150 km, about 175 km, about 200 km, about 225 km, about 250 km, about 275 km, about 300 km, about 325 km, about 350 km, about 375 km, about 400 km, about 425 km, about 450 km, about 475 km, about 500 km, about 550 km, about 600 km, about 650 km, about 700 km, about 750 km, about 800 km, about 850 km, about 900 km, about 950 km, about 1000 km, or greater. In some examples, the distance d ranges from about 15 km to about 60 km, from about 20 km to about 100 km, from about 60 km to about 120 km, from about 100 km to about 1000 km, from about 100 km to about 200 km, from about 200 km to about 300 km, from about 300 km to about 400 km, from about 400 km to about 500 km, from about 500 km to about 600 km, from about 600 km to about 700 km, from about 700 km to about 800 km, from about 800 km to about 900 km, from about 900 km to about 1000 km, or greater. For longer distances d (e.g., greater than 100 km) between two transponders (e.g., transponders 105a and 105b), intermediate amplifiers (e.g., amplifier(s) 145c and/or 145d) can be used between the two transponders to amplify optical signals carried by each of the at least one HCF cable 165. In examples, the first transponder 105a and the second transponder 105b are part of an optical line system (“OLS”) or an optical network line system (“ONLS”). The OLS or ONLS is an optical network system that combines multiple wavelength-specific coherent optics including multiplexers/demultiplexers, optical add-drop multiplexers (“OADMs”), reconfigurable optical add-drop multiplexers (“ROADMs”), wavelength selective switches, optical amplifiers, optical monitoring systems, and/or power management tools.

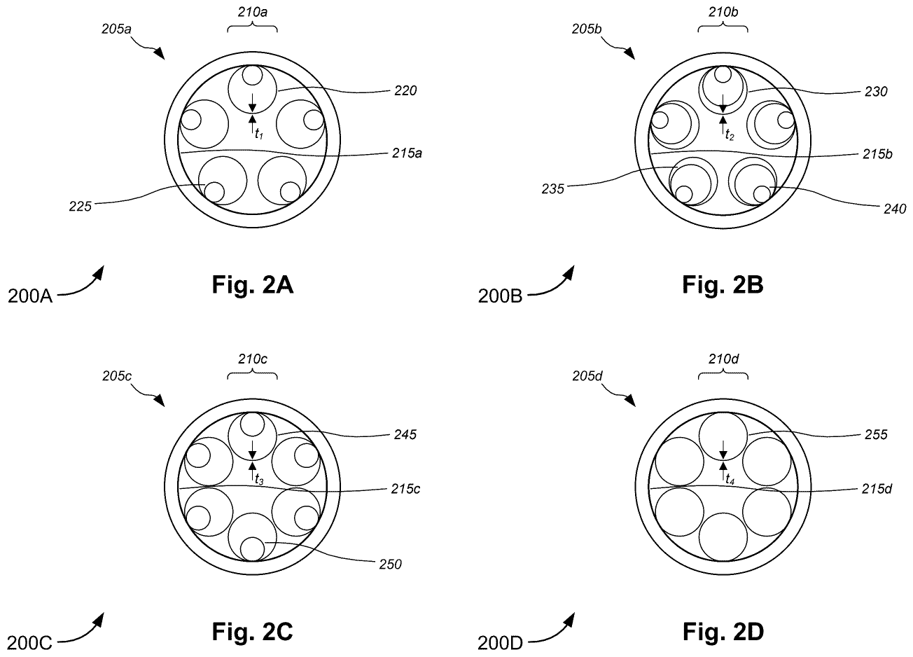

In some examples, as shown in FIG. 1 by the partial cross-section of the at least one HCF cable 165, each HCF cable 165 includes a cladding 195a, an inner surface 195b of the cladding 195a, a hollow core 195c defined by the cladding 195a, and a plurality of nested tubes 195d formed on the inner surface 195b and within the hollow core 195c. In the example of FIG. 1, five sets of nested tubes 195d are formed on an inner surface 195b of the cladding 195a of the HCF cable 165. In some examples, such as shown in FIG. 1, each set of nested tubes has a hollow tube 195f nested within hollow tube 195e. Each hollow tube 195e or 195f is formed from a membrane having a thickness t. In some cases, the thicknesses of hollow tubes 195e and 195f are the same. In other cases, the thickness of hollow tube 195e is different from the thickness of hollow tube 195f. FIGS. 2A-2D depict other example HCF cables having different example configurations of the nested tubes with corresponding membrane thicknesses.

Turning back to FIG. 1, in examples, the second transponder 105b includes a mux/demux module 110b, an optical module 115b, and a controller 120b and/or a computing system 125b. The mux/demux module 110b includes a mux 130b and a demux 135b. The optical module 115b includes receiver components including an input port(s) 170b, a pre-amplifier (“PA”) 175b, optical filters/extractors 180, and a plurality of OSC systems 155e-155h. The input port(s) 170b receives data signal 140b that has been transmitted over HCF cable(s) 165a—and, in some cases, amplified by intermediate amplifier(s) 145c (if any between the first and second transponders 105a and 105b). Each of the optical filters/extractors 180 filters or extracts, from data signal 140b, one of the plurality of OSC signals at a corresponding one of the plurality of wavelengths λ₁-λ₄, in some cases, using a bandpass filter or other filter that filters based on a range of wavelengths centered around one of wavelengths λ₁-λ₄. In the case that WDM is used to multiplex the data signal 140a (at the wavelength λ_{S1}) and the plurality of OSC signals (at the wavelengths λ₁-λ₄), WDM is used to demultiplex the plurality of OSC signals and the data signal 140b. The filtered or extracted OSC signals are each input into a corresponding one of the plurality of OSC systems 155e-155h, each of which includes an OSC detector that is used to detect the corresponding filtered or extracted OSC signal. Each OSC detector is one of (i) a fixed wavelength signal detector that detects optical signals at either a single, fixed wavelength or a single, fixed wavelength range; or (ii) a tunable wavelength signal detector that detects optical signals at either a selected wavelength or a selected wavelength range based on an input indicating the selected wavelength or selected wavelength range of the optical signals. In some cases, the fixed wavelength signal detector includes fixed wavelength photodetector, while the tunable wavelength signal detector includes a tunable wavelength photodetector. The data signal 140b that remains, and which is at a second signal wavelength (Asr) that corresponds to the first signal wavelength (As), is amplified by PA 175b. In the case that an OSC signal is injected into the data signal 140a prior to data signal 140a being amplified by BA 145a (such as OSC signal at wavelength 14 that is generated by OSC 155d), an optical filter/extractor 180 is used to filter or extract that OSC signal after being amplified by PA 175b. The filtered and extracted OSC signal is detected by an OSC detector of OSC system 155h. The resultant data signal is input into demux 135b, which demultiplexes the data signal 140b and outputs multiple output data signals (denoted by the plurality of arrows that are shown exiting the demux 135b).

For sending data signals from the second transponder 105b to the first transponder 105a, each of the first and second transponders 105a and 105b further includes both sets of transmitter components and receiver components. That is, the mux/demux module 110b of the second transponder 105b further includes a mux 130b that is similar, if not identical, to mux 130a of the mux/demux 110a of the first transponder 105a. The optical module 115b of the second transponder 105b further includes transmitter components including a BA 145b, an output port(s) 150b, and optical couplers 160, which are similar, if not identical, to the BA 145a, the output port(s) 150a, and the optical couplers 160 of the optical module 115a of the first transponder 105a. The plurality of OSC systems 155e-155h further includes a corresponding plurality of OSC generators that is similar, if not identical, to the plurality of OSC generators of the plurality of OSC systems 155a-155d of the first transponder 105a. The optical module 115a of the first transponder 105a further includes receiver components including an input port(s) 170a, a PA 175a, and optical filters/extractors 180, which are similar, if not identical, to the input port(s) 170b, the PA 175b, and the optical filters/extractors 180 of the optical module 115b of the second transponder 105b. The plurality of OSC systems 155a-155d of the first transponder 105a each further includes an OSC detector that is similar, if not identical, to the OSC detector of each of the plurality of OSC systems 155e-155h of the second transponder 105b. The demux 135a of the mux/demux module 110a of the first transponder 105a is similar, if not identical, to demux 135b of the mux/demux module 110b of the second transponder 105b.

The mux 130b in the second transponder 105b receives multiple input data signals (denoted by the plurality of arrows that are shown entering the mux 130b) and outputs a multiplexed data signal 140c at a third signal wavelength (λ_{S2}) that is input into the optical module 115b. The BA 145b amplifies the data signal 140c. The OSC generator of each of the plurality of OSC systems 155e-155h generates an OSC signal at a corresponding one of the plurality of wavelengths λ₁-λ₄. Each of the optical couplers 160 injects one of the plurality of OSC signals (at one of the wavelengths λ₁-λ₄) into the data signal 140c (at signal wavelength λ_{S2}), and the resultant multiplexed signal is output from the output port(s) 150b. In some examples, a WDM system is used, in place of the optical couplers 160, to multiplex the data signal 140c (at the wavelength λ_{S2}) and the plurality of OSC signals (at the wavelengths λ₁-λ₄). The resultant multiplexed signal is transmitted over at least one HCF cable 165b that communicative couples the second transponder 105b to the first transponder 105a. The input port(s) 170a receives data signal 140d that has been transmitted over HCF cable(s) 165b—and, in some cases, amplified by intermediate amplifier(s) 145d (if any between the first and second transponders 105a and 105b). Each of the optical filters/extractors 180 filters or extracts, from data signal 140d, one of the plurality of OSC signals at a corresponding one of the plurality of wavelengths λ₁-λ₄, in some cases, using a bandpass filter or other filter that filters based on a range of wavelengths centered around one of wavelengths λ₁-λ₄. In the case that WDM is used to multiplex the data signal 140c (at the wavelength λ_{S2}) and the plurality of OSC signals (at the wavelengths λ₁-λ₄), WDM is used to demultiplex the plurality of OSC signals and the data signal 140d. The filtered or extracted OSC signals are each input into a corresponding one of the plurality of OSC systems 155a-155d, the OSC detector of each of which being used to detect the corresponding filtered or extracted OSC signal. The data signal 140d that remains, and which is at a fourth signal wavelength (λ_{S2′}) that corresponds to the third signal wavelength (λ_{S2}), is amplified by PA 175a. In the case that an OSC signal is injected into the data signal 140c prior to data signal 140c being amplified by BA 145b (such as OSC signal at wavelength 24 that is generated by OSC 155h), an optical filter/extractor 180 is used to filter or extract that OSC signal after being amplified by PA 175a. The filtered and extracted OSC signal is detected by an OSC detector of OSC system 155d. The resultant data signal is input into demux 135a, which demultiplexes the data signal 140d and outputs multiple output data signals (denoted by the plurality of arrows that are shown exiting the demux 135a).

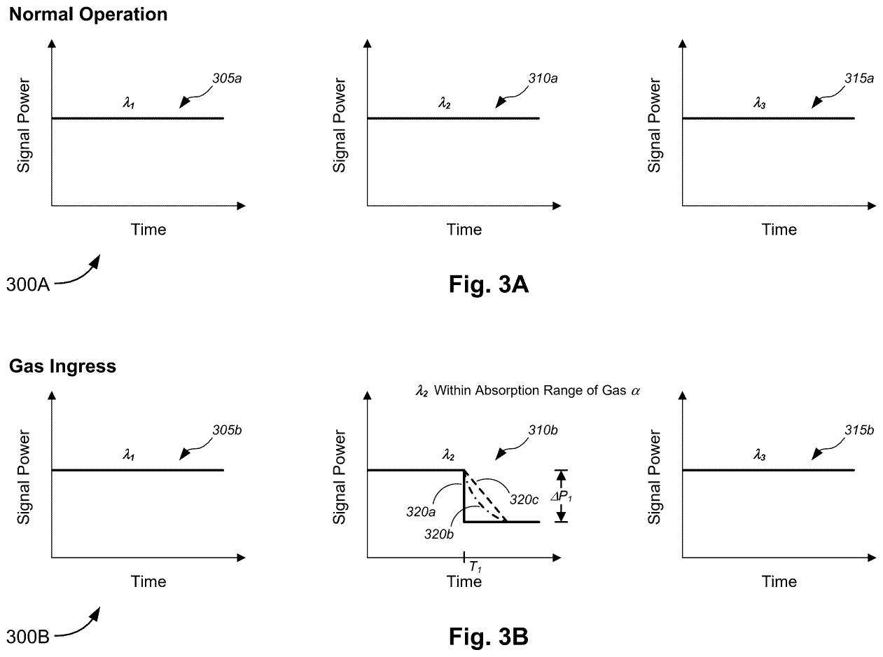

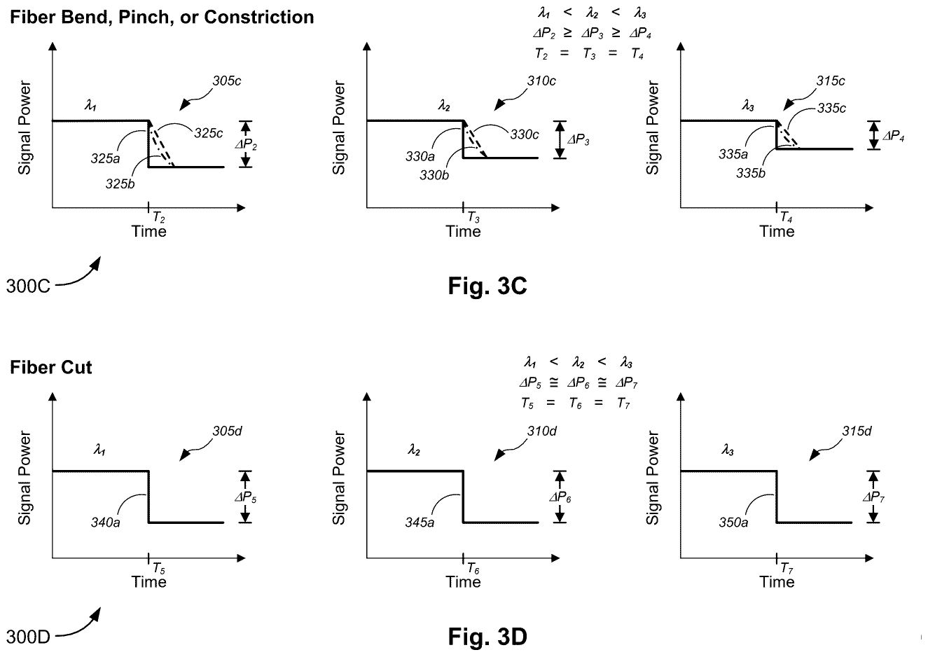

In conventional line systems, especially SCF-based optical network line systems, an OSC monitors whether there is a fault in a dark fiber (e.g., along a fiber path between two transponders). If there is no fault, the OSC signal power does not degrade over time. If there is a fault, however, such as a fiber break or a fiber bend, the OSC signal power will degrade either instantaneously or over time, respectively. In SCF-based optical network line systems, additional OSCs cannot be sustained because the increased signal power from another OSC light source can cause the optical network line system to experience optical nonlinearities, which adversely affects signals transmitted over the SCF (e.g., data signal transmissions as well as OSC signal transmissions). Where there is only a single OSC channel, a drop in OSC signal power could be due to a fiber break, a fiber bend, an imperfect connection, amongst other potential causes, without clarity on which potential cause is more likely to be the actual cause. Quite differently, because HCFs are capable of high optical power transmissions without incurring non-linearities, HCF-based optical network line systems can be configured to include multiple OSC transmitters whose OSC signals can be multiplexed with the optical data signals. The multiple OSC signals allow for detecting and identifying potential causes, as described in detail below with respect to FIGS. 3A-3D.

System 100 further includes a computing system 125 and a datastore 185 that are remote from either the first transponder 105a or the second transponder 105b. Alternatively or additionally, in the case that the transponder 105 (whether first transponder 105a or second transponder 105b) includes a computing system (e.g., computing system 125a of the first transponder 105a or computing system 125b of the second transponder 105b), the transponder 105 further includes a corresponding datastore (e.g., datastore 185a for the first transponder 105a or datastore 185b for the second transponder 105b). One or more of datastores 185, 185a, and/or 185b are used to store OSC signals (e.g., OSC signals 190a-190z corresponding to the OSC signals detected by the OSC detectors of the plurality of OSC systems 155a-155h, in some cases, over a lifetime of the transponder 105 and/or the HCF cables 165. In some examples, the datastore 185a stores OSC signals 190 corresponding to one or more of the OSC signals generated by OSC systems 155a-155d of the first transponder 105a, the OSC signals received and detected by OSC systems 155a-155d of the first transponder 105a, the OSC signals corresponding to operations of the first transponder 105a and/or the second transponder 105b, and/or the OSC signals corresponding to signals transmitted from and/or to the first transponder 105a over a corresponding at least one HCF cable 165. Similarly, the datastore 185b stores OSC signals 190 corresponding to one or more of the OSC signals generated by OSC systems 155e-155h of the second transponder 105b, the OSC signals received and detected by OSC systems 155e-155h of the second transponder 105b, the OSC signals corresponding to operations of the first transponder 105a and/or the second transponder 105b, and/or the OSC signals corresponding to signals transmitted from and/or to the second transponder 105b over a corresponding at least one HCF cable 165. In some instances, the datastore 185 stores OSC signals 190 corresponding to operations of a plurality of transponders (which includes the first and second transponders 105a and 105b, as well as other transponders), and/or the OSC signals corresponding to signals transmitted from and/or to each of the plurality of transponders over a corresponding at least one HCF cable 165.

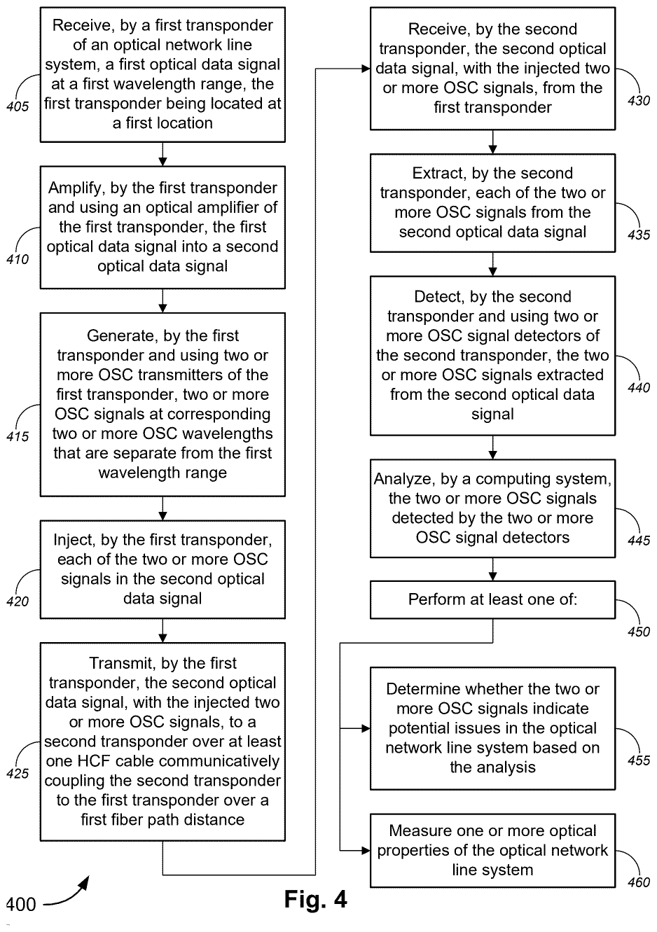

In operation, the computing system 125, the first and/or second transponders 105a and/or 105b, and/or corresponding components of the first and/or second transponders 105a and/or 105b (including controller 120a/120b, computing system 125a/125b, the mux/demux 110a/110b, and/or the optical module 115a/115b) may perform methods for implementing an HCF-based optical network line system with multiple multiplexed optical supervisory channels, as described in detail with respect to FIGS. 2A-4. For example, example configurations 200A-200D as described below with respect to FIGS. 2A-2D, example sets of OSC signal profiles 300A-300D as described below with respect to FIGS. 3A-3D, and method 400 as described below with respect to FIG. 4 may be applied with respect to the operations of system 100 of FIG. 1.

FIGS. 2A-2D depict cross-sectional views of various example configurations 200A-200D of HCFs when implementing an HCF-based optical network line system with multiple multiplexed optical supervisory channels. In the example configuration 200A of FIG. 2A, HCF 205a includes a plurality of nested tubes 210a (in this case, five sets of nested tubes 210a) formed on an inner surface 215a of the HCF 205a. In some examples, such as shown in FIG. 2A, each set of nested tubes has a hollow tube 225 nested within hollow tube 220. A membrane of each hollow tube 220 or 225 is formed having a thickness t₁. In some cases, the thicknesses of hollow tubes 220 and 225 are the same. In other cases, the thickness of hollow tube 220 is different from the thickness of hollow tube 225. In the example configuration 200B of FIG. 2B, HCF 205b includes a plurality of nested tubes 210b (in this case, five sets of nested tubes 210b) formed on an inner surface 215b of the HCF 205b. In some examples, such as shown in FIG. 2B, each set of nested tubes has a hollow tube 240 nested within hollow tube 235, which is in turn nested within hollow tube 230. A membrane of each hollow tube 230, 235, or 240 is formed having a thickness t₂. In some cases, the thicknesses of hollow tubes 230, 235, or 240 are the same. In other cases, the thickness of each of hollow tubes 230, 235, and 240 is different from the thickness of other ones of hollow tubes 230, 235, or 240. In the example configuration 200C of FIG. 2C, HCF 205c includes a plurality of nested tubes 210c (in this case, six sets of nested tubes 210c) formed on an inner surface 215c of the HCF 205c. In some examples, such as shown in FIG. 2C, each set of nested tubes has a hollow tube 250 nested within hollow tube 245. A membrane of each hollow tube 245 or 250 is formed having a thickness t₃. In some cases, the thicknesses of hollow tubes 245 and 250 are the same. In other cases, the thickness of hollow tube 245 is different from the thickness of hollow tube 250. In the example configuration 200D of FIG. 2D, HCF 205d includes a plurality of tubular elements 210d (in this case, six sets of tubular elements 210d) formed on an inner surface 215d of the HCF 205d. In some examples, such as shown in FIG. 2D, each set of tubular elements has a hollow tube 255. A membrane of each hollow tube 255 is formed having a thickness t₄.

Given a wavelength over which data signals or OSC signals are to be transmitted, membrane thickness t (such as t₁-t₄ of FIGS. 2A-2D) can be determined based on the following equation (although not limited to this equation):

$$t = \frac{m \cdot {λ}_{m}}{2 \cdot \sqrt{( {n}^{2} - 1 )}} \qquad ( Eqn . 1 )$$

where m is an integer (e.g., m=1, 2, 3, . . . ) and n is a refractive index of the material of the HCF (e.g., silica).

Conversely, given the membrane thickness t and a refractive index n of the HCF material, resonant wavelength can be determined based on the following equation (although not limited to this equation):

$${λ}_{m} = \frac{2 t}{m} \sqrt{( {n}^{2} - 1 )} \qquad ( Eqn . 2 )$$

The singular thickness and/or wavelength that result from these equations may be a central or target point about which a resonant window is formed. Similarly, anti-resonant windows exist between the resonant windows.

As used herein, resonant wavelength corresponds to a wavelength of light that couples with a material of the HCF cable. By contrast, an anti-resonant wavelength corresponds to a wavelength of light that propagates along a hollow core portion of the HCF without coupling (or minimal coupling) with the material of the HCF cable. For an HCF that is made of silica (e.g., silica having refractive index of 1.4444) and with a known membrane thickness of 500 nm, integer values m=1, 2, and 3 of the corresponding resonant wavelengths for the HCF are as follows: 1042 nm, 521 nm, and 347 nm (according to Eqn. 2). Except for the fundamental window (e.g., the n=1 case), anti-resonant wavelengths lie within anti-resonant windows between these resonant wavelengths at their corresponding integer values. The fundamental window (where n=1) is defined by a resonant window at the short wavelength edge (also referred to herein as a first wavelength edge; e.g., <1.5 μm) and by loss due to leakage, material absorption, and/or microbend losses, etc., at the long wavelength edge (also referred to herein as a second wavelength edge; e.g., >1.5 μm). U.S. patent application Ser. No. 18/931,429 (the “'429 application”), filed Oct. 30, 2024, by Matthew Artus Tuggle et al., entitled, “Hollow Core Fiber-Based Line-System With Out-Of-Band Optical Supervisory Channel,” the disclosure of which is incorporated herein by reference in its entirety for all purposes, describes in detail resonant and anti-resonant windows. For example, FIG. 3B of the '429 application depicts anti-resonant windows relative to resonant windows. For a similar HCF having membrane thickness of 700 nm, for example, the corresponding resonant wavelengths (with anti-resonant wavelengths therebetween), for integer values m=1, 2, and 3, are as follows: 1459 nm, 730 nm, and 486 nm. For a similar HCF having membrane thickness of 800 nm, for example, the corresponding resonant wavelengths (with anti-resonant wavelengths therebetween), for integer values m=1, 2, and 3, are as follows: 1668 nm, 834 nm, and 556 nm. In some examples, given a choice of signal wavelength (or a range of wavelengths, e.g., C-band), and/or OSC wavelength (or potentially OSC wavelengths) a choice of membrane thickness and m values are identified (in some cases, using Eqn. 1 or 2) to ensure that the signal and OSC channels are well away from resonant wavelengths, and in sufficiently wide anti-resonant windows to ensure low losses for the signal and OSC wavelengths. In an example, OSC and data wavelengths are operated in the first anti-resonant window.

In other examples, given a wavelength of a laser for use to transmit the data signal or the OSC signal, a membrane thickness t can be determined using Eqn. 1 as follows. A first membrane thickness value is first calculated based on a first resonant window corresponding to a first resonant wavelength larger than the wavelength of the laser. Next, a second membrane thickness value is calculated based on a second resonant window corresponding to a second resonant wavelength smaller than the wavelength of the laser. In an example, the membrane thickness t is then calculated by selecting a third membrane thickness value between the first membrane thickness value and the second membrane thickness value, the third membrane thickness value corresponding to an anti-resonant window that lies between the first resonant window and the second resonant window. In other examples, detailed simulations involving a number of parameters are used to establish an optimum fiber structure (e.g., thickness and geometry of the HCF cable) to minimize loss at the signal and/or OSC wavelengths, the thickness and geometry including tube sizes and thicknesses, core size and thickness, a number of tubes, a number of elements, etc. In an example, for a laser wavelength of 1300 nm, the first resonant wavelength and the second resonant wavelength are selected to be, e.g., 1400 nm and 1200 nm. The corresponding membrane thickness values, according to Eqn. 1, are: 672 nm and 576 nm, respectively. An example third membrane thickness value is 600 nm (selected between 672 nm and 576 nm), which corresponds to the membrane thickness t. A first HCF for transmitting data signals at a wavelength of 1550 nm can be manufactured with nested tubes having a membrane thickness of 750 nm. A second HCF for transmitting OSC signals at a wavelength of 1300 nm can be manufactured with nested tubes having a membrane thickness of 600 nm. In yet another example, for a laser wavelength of 632 nm (such as for a helium-neon or HeNe laser, which is an inexpensive laser), the first resonant wavelength and the second resonant wavelength are selected to be about 732 nm and 532 nm. The corresponding membrane thickness values, according to Eqn. 1, are: 351 nm and 255 nm, respectively. An example third membrane thickness value is 300 nm (selected between 351 nm and 255 nm), which corresponds to the membrane thickness t. In some cases, selecting the third membrane thickness value includes selecting a membrane thickness corresponding to a center wavelength at which measured loss is low (such as shown in the loss measurement graph of FIG. 3A of the '429 application).

FIGS. 3A-3D depict various example sets of OSC signal profiles 300A-300D corresponding to normal operations and to various potential issues in the optical network line system when implementing an HCF-based optical network line system with multiple multiplexed optical supervisory channels. Although FIGS. 3A-3D correspond to an optical network line system having three OSCs at OSC wavelengths (e.g., λ₁-λ₃ of FIG. 1) that are multiplexed with a data signal (e.g., λ_{S1} of FIG. 1), the various embodiments are not so limited, and any suitable number of OSCs may be multiplexed with the data signal.

Example set of OSC signal profiles 300A of FIG. 3A illustrates relative signal powers for λ₁-λ₃ OSC signals 305a, 310a, and 315a, respectively, that—when received, extracted/demultiplexed/filtered, and detected by OSC detectors at a receiving-side transponder then analyzed collectively—indicate normal operations of the optical network line system over an HCF between two transponders (e.g., HCF 165a or 165b between transponders 105a and 105b of FIG. 1). Example sets of OSC signal profiles 300B-330D of FIGS. 3B-3D, on the other hand, illustrate relative signal powers for λ₁-λ₃ OSC signals 305b, 310b, and 315b, respectively, of FIG. 3B, for λ₁-λ₃ OSC signals 305c, 310c, and 315c, respectively, of FIG. 3C, and for λ₁-λ₃ OSC signals 305d, 310d, and 315d, respectively, of FIG. 3D, that, when similarly detected, indicate potential issues with operations of the optical network line system.

As shown in FIG. 3A, the signal powers for each of the λ₁-λ₃ OSC signals 305a, 310a, and 315a, respectively, as detected at the receiving-side transponder, remain relatively unchanged over time (e.g., over the span of seconds, minutes, hours, days, weeks, months, or years). In examples, a data signal is transmitted over an HCF data path between two transponders (e.g., at least one HCF or HCF cable 165a or 165b communicatively coupling the first and second transponders 105a and 105b of FIG. 1) at a signal wavelength or a signal wavelength range (e.g., λ_{S1} of FIG. 1, in some cases, with wavelength values between about 1522 nanometers (nm) and about 1567 nm). In an example, multiple OSCs are multiplexed with the data signal, with a first OSC signal 305a (e.g., at wavelength λ₁), a second OSC signal 310a (e.g., at wavelength 22), and a third OSC signal 315a (e.g., at wavelength λ₃) being generated and transmitted at wavelength values of 850 nm, 1310 nm or 1383 nm, and 1510 nm or 1600, respectively, and then received, extracted/demultiplexed/filtered, and detected at the receiving-side transponder. In some cases, the OSC signal power is about 1 decibel-milliwatt (dBm), or a value (i.e., the same value) within a range between about −40 to about +30 dBm, for each of these λ₁-λ₃ OSC signals 305a, 310a, and 315a, respectively.

Referring to FIG. 3B, example set of OSC signal profiles 300B illustrates relative signal powers for λ₁-λ₃ OSC signals 305b, 310b, and 315b, respectively, that indicate gas ingress in the HCF along which the optical data signal and the multiplexed OSC signals propagate (or are transmitted). In some examples, one of the λ₁-λ₃ OSC signals 305b, 310b, and 315b can be targeted for detecting ingress or presence of a gas α within the HCF, by using a wavelength for that OSC signal that is within a wavelength absorption range for that gas. In examples, gas α includes water (H₂O) vapor, hydroxyl (OH) gas, carbon monoxide (CO) gas, or other potential optical fiber contaminant gas. Taking water vapor, for instance, and using the example wavelength values discussed in the example above with respect to FIG. 3A, a wavelength of about 1383 nm can be used to monitor the presence of water vapor in the HCF, water vapor having a wavelength absorption between about 1340 and about 1500 nm. As shown in FIG. 3B, signal powers of the first and third OSC signals 305b and 315b (e.g., at wavelength λ₁ below 1340 nm (e.g., at about 850 nm) and at wavelength λ₃ above 1500 nm (e.g., at about 1510 nm or about 1600 nm)) remain relatively unchanged (e.g., at about 1 dBm). The signal power of the second OSC signal 310b (e.g., at wavelength λ₂ within the range between about 1340 nm and about 1500 nm (e.g., at about 1383 nm)), however, drops at time T₁, which is indicative of water vapor ingress in the HCF, such as when there is a fiber break or other opening in the HCF. In examples, the drop 320 in the signal power of the second OSC signal 310b is either a sharp drop (as denoted in FIG. 3B by the step-wise drop 320a) or a gradual drop 320b/320c in power (as denoted in FIG. 3B by one of the curved dot-dash lined drop 320b or the straight dashed lined drop 320c from high signal power to low signal power for the second OSC signal 310b (e.g., at wavelength λ₂)). In either case, the drop 320 in signal power (represented by a ΔP₁ value) is about −0.1, −0.3, −0.5, −1, −10, −15, −20, or −80 decibels (dB), or within a range of between about −0.1 and about −80 dB. In examples, the gradual drop 320b or 320c occurs over a time period of microseconds, milliseconds, seconds, or minutes after time T₁.

In another example, example set of OSC signal profiles 300C of FIG. 3C illustrates relative signal powers for λ₁-λ₃ OSC signals 305c, 310c, and 315c, respectively, that indicate one of a fiber bend, a fiber pinch, or a fiber constriction along the HCF along which the optical data signal and the multiplexed OSC signals propagate (or are transmitted). Using the example wavelength values discussed in the example above with respect to FIG. 3A, a wavelength dependent signal power degradation and/or a staggered time for signal drops depending on wavelength of the OSC signals can indicate a fiber bend, a fiber pinch, or a fiber constriction along the HCF. As shown in FIG. 3C, signal powers of each of the first through third OSC signals 305c, 310c, and 315c (e.g., at wavelength λ₁ of about 850 nm, at wavelength 12 of about 1310 nm or about 1383 nm, and at wavelength λ₃ of about 1510 nm or about 1600 nm)) drop at times T₂, T₃, and T₄, respectively, where times T₂, T₃, and T₄ are substantially the same or approximately concurrent, if not simultaneous. If there is a bend in the HCF, the shortest wavelength signal would degrade more than the longest wavelength signal due to shorter wavelengths being more prone to bend-induced scattering, resulting in signal drops being greater for shorter wavelength signals compared with longer wavelength signals. In some examples, each of the drops 325, 330, and 335 in signal power (represented by λP₂, λP₃, and λP₄ values, respectively) is about −0.1, −0.3, −0.5, −1, −10, −15, −20, or −40 dB, or within a range of between about −0.1 and about −40 dB, with ΔP₂≥ΔP₃≥ΔP₄. FIG. 3C further illustrates the wavelength-dependent staggered time for signal degradation, with λ₁<λ₂<λ₃, where a fiber bend, pinch, or constriction results in a drop 325 in the first OSC signal 305c occurring at time T₂, a drop 330 in the second OSC signal 310c at time T₃, and a drop 335 in the third OSC signal 315c at time T₄, where times T₂, T₃, and T₄ are substantially the same or approximately concurrent, if not simultaneous. In an example, each of the drops 325, 330, and 335 in the corresponding signal powers of the λ₁-λ₃ OSC signals 305c, 310c, and 315c is a sharp drop in power (as denoted in FIG. 3C by the step-wise drops 325a, 330a, and 335a, respectively). Alternatively, each of the drops 325, 330, and 335 is a gradual drop 325b/325c, 330b/330c, or 335b/335c in power (as denoted in FIG. 3C by one of the curved dot-dash lined drops 325b, 330b, and 335b or the straight dashed lined drops 325c, 330c, and 335c from high signal power to low signal power for the OSC signals 305c, 310c, and 315c). In examples, the gradual drops 325b/325c, 330b/330c, or 335b/335c occur over a time period of microseconds, milliseconds, seconds, or minutes after time T₂, T₃, and T₄, respectively.

In yet another example, example set of OSC signal profiles 300D of FIG. 3D illustrates relative signal powers for λ₁-λ₃ OSC signals 305d, 310d, and 315d, respectively, that indicate a fiber cut in the HCF along which the optical data signal and the multiplexed OSC signals propagate (or are transmitted). Using the example wavelength values discussed in the example above with respect to FIG. 3A, simultaneous signal power degradation for all the λ₁-λ₃ OSC signals 305d, 310d, and 315d can indicate a fiber cut along the HCF. As shown in FIG. 3D, signal powers of each of the first through third OSC signals 305d, 310d, and 315d (e.g., at wavelength λ₁ of about 850 nm, at wavelength λ₂ of about 1310 nm or about 1383 nm, and at wavelength λ₃ of about 1510 nm or about 1600 nm)) drop at times T₅, T₆, and T₇, respectively, where times T₅, T₆, and T₇ are substantially the same or approximately concurrent, if not simultaneous. In examples, each of the drops 340, 345, and 350 in the corresponding signal powers of the λ₁-λ₃ OSC signals 305d, 310d, and 315d is a sharp drop in power (as denoted in FIG. 3D by the step-wise drops 340a, 345a, and 350a, respectively). In some examples, each of the drops 340, 345, and 350 in signal power (represented by ΔP₅, ΔP₆, and ΔP₇ values, respectively) is a full drop (e.g., about −80 dB), in some cases, with ΔP₅, ΔP₆, and ΔP₇ being approximately the same.

With the use of multiple OSC signals, other characteristics of the optical network line system—including chromatic dispersion, polarization mode dispersion, length of HCF (particularly over the lifetime of the system where infrastructure changes have been implemented), and/or amplifier operational status—may be determined or measured. To precisely measure chromatic dispersion, one can utilize the dispersion differential for two or more signals. In an example, for a 1510 nm signal where chromatic dispersion (“CD”) is zero picoseconds per nanometer-kilometer (ps/nm·km) and a 1570 nm signal where the CD is 2-3 ps/nm·km, for a 20 km fiber path distance, the chromatic dispersion would be drastically different between the two signals, allowing for precise measurement of the dispersion over the length of the fiber. Moreover, one could utilize a third OSC channel (e.g., a 1310 nm signal), where dispersion is negative for additional characterization of the dispersion properties in real-time during network operation. In another example, where zero chromatic dispersion occurs at 600 nm (λ₀) and assuming 3 ps/nm·km for every 250 nm increase in wavelength, for a signal wavelength between about 1529 nm (λ_{S1}) and 1567 nm (λ_{S2}), with three OSC channels at 850 nm (λ₁), 1310 nm (λ₂), and 1510 nm (λ₃), chromatic dispersion can be calculated as follows, based on an overall ratio of signal-to-noise ratios (“SNRs”) of dispersion:

$$D ( λ ) = D ( {λ}_{0} ) + S ( λ - {λ}_{0} ) , \qquad ( Eqn . 3 )$$

$$PB ( λ ) = L \times PW \times D ( λ ) , and \qquad ( Eqn . 4 )$$

$${R}_{SNR} ( λ / {λ}_{S} ) = \frac{SNR ( λ )}{SNR ( {λ}_{S} )} = \frac{( 1 / PB ( λ ) )}{( 1 / PB ( {λ}_{S} ) )} , \qquad ( Eqn . 5 )$$

where D(λ) is the dispersion for a given wavelength, D(λ₀) is the dispersion for the zero dispersion wavelength, S is the estimated dispersion rate constant, PB(λ) is pulse broadening for a given wavelength, PW is the pulse width of the signal (e.g., a pulse width of 1 nm), L is the length of the HCF, R_{SNR}(λ/λ_{S}) is the ratio of an SNR for an OSC signal compared to an SNR for a data signal, SNR(λ) is the SNR for the OSC signal, and SNR(λ_{S}) is the SNR for the data signal.

Using the values in the example above, overall ratios of SNRs of dispersion are calculated as follows:

$$\begin{matrix}D ( {λ}_{1} ) = D ( {λ}_{0} ) + S ( {λ}_{1} - {λ}_{0} ) \\ D ( 850 ) = D ( 60 \; 0 ) + S ( 850 - 600 ) , \\ = 0 + 3 / 250 ( 250 ) = 3. ps / nm \cdot km ,\end{matrix} \qquad ( Eqn . 3 a )$$

$$\begin{matrix}D ( {λ}_{2} ) = D ( {λ}_{0} ) + S ( {λ}_{2} - {λ}_{0} ) \\ D ( 13 \; 10 ) = D ( 60 \; 0 ) + S ( 1310 - 600 ) , \\ = 0 + 3 / 250 ( 710 ) = 8.5 ps / nm \cdot km ,\end{matrix} \qquad ( Eqn . 3 b )$$

$$\begin{matrix}D ( {λ}_{3} ) = D ( {λ}_{0} ) + S ( {λ}_{3} - {λ}_{0} ) \\ D ( 15 \; 10 ) = D ( 60 \; 0 ) + S ( 1510 - 600 ) , \\ = 0 + 3 / 250 ( 910 ) = 1 0.9 ps / nm \cdot km ,\end{matrix} \qquad ( Eqn . 3 c )$$

$$\begin{matrix}D ( {λ}_{S 2} ) = D ( {λ}_{0} ) + S ( {λ}_{S 2} - {λ}_{0} ) \\ D ( 15 \; 67 ) = D ( 60 \; 0 ) + S ( 1567 - 600 ) , \\ = 0 + 3 / 250 ( 967 ) = 1 1.6 ps / nm \cdot km ,\end{matrix} \qquad ( Eqn . 3 d )$$

$$\begin{matrix}PB ( {λ}_{1} ) = L \times D ( {λ}_{1} ) \\ PB ( 850 ) = 20 \times 1 \times D ( 850 ) = 20 \times 1 \times 3 \\ = 60 ps ,\end{matrix} \qquad ( Eqn . 4 a )$$

$$\begin{matrix}PB ( {λ}_{2} ) = L \times PW \times D ( {λ}_{2} ) \\ PB ( 1310 ) = 20 \times 1 \times D ( 1310 ) = 20 \times 1 \times 8.5 \\ = 170 ps ,\end{matrix} \qquad ( Eqn . 4 b )$$

$$\begin{matrix}PB ( {λ}_{3} ) = L \times PW \times D ( {λ}_{3} ) \\ PB ( 15 \; 10 ) = 20 \times 1 \times D ( 1510 ) = 20 \times 1 \times 10.9 \\ = 218 ps ,\end{matrix} \qquad ( Eqn . 4 c )$$

$$\begin{matrix}PB ( {λ}_{S 2} ) = L \times PW \times D ( {λ}_{S 2} ) \\ PB ( 1567 ) = 20 \times D ( 1567 ) = 20 \times 1 \times 11.6 \\ = 232 ps ,\end{matrix} \qquad ( Eqn . 4 d )$$

$$\begin{matrix}{R}_{SNR} ( {λ}_{1} / {λ}_{S 2} ) = \frac{SNR ( {λ}_{1} )}{SNR ( {λ}_{S 2} )} = \frac{( 1 / PB ( {λ}_{1} ) )}{( 1 / PB ( {λ}_{S 2} ) )} \\ {R}_{SNR} ( 850 / 1567 ) = \frac{SNR ( 850 )}{SNR ( 1567 )} = \frac{( 1 / PB ( 850 ) )}{( 1 / PB ( 1567 ) )} \\ = \frac{( 1 / 60 )}{( 1 / 232 )} = 3 \text{.87} ,\end{matrix} \qquad ( Eqn . 5 a )$$

$$\begin{matrix}{R}_{SNR} ( {λ}_{2} / {λ}_{S 2} ) = \frac{SNR ( {λ}_{2} )}{SNR ( {λ}_{S 2} )} = \frac{( 1 / PB ( {λ}_{2} ) )}{( 1 / PB ( {λ}_{S 2} ) )} \\ {R}_{SNR} ( 1 \; 310 / 1567 ) = \frac{SNR ( 1310 )}{SNR ( 1567 )} = \frac{( 1 / PB ( 1310 ) )}{( 1 / PB ( 1567 ) )} \\ = \frac{( 1 / 170 )}{( 1 / 232 )} = 1.36 , and\end{matrix} \qquad ( Eqn . 5 b )$$

$$\begin{matrix}{R}_{SNR} ( {λ}_{3} / {λ}_{S 2} ) = \frac{SNR ( {λ}_{3} )}{SNR ( {λ}_{S 2} )} = \frac{( 1 / PB ( {λ}_{3} ) )}{( 1 / PB ( {λ}_{S 2} ) )} \\ {R}_{SNR} ( 1 \; 510 / 1567 ) = \frac{SNR ( 1510 )}{SNR ( 1567 )} = \frac{( 1 / PB ( 1510 ) )}{( 1 / PB ( 1567 ) )} \\ = \frac{( 1 / 218 )}{( 1 / 232 )} = 1.06 .\end{matrix} \qquad ( Eqn . 5 c )$$

In examples, polarization mode dispersion is a form of modal dispersion in which two or more different polarizations of light in a fiber (e.g., an HCF), such as when different polarizers are used to provide different polarizations to two or more OSC signals prior to multiplexing the two or more OSC signals, travel at different speeds along the fiber due to random imperfections and asymmetries. The random imperfections and asymmetries result in random spreading of optical pulses, which can limit the rate at which data signals can be transmitted over the fiber unless compensated for. In some instances, a polarization component analyzer can be used to measure the polarization mode dispersion, in some cases, by measuring time differentials for the different polarizations of light to travel the length of the fiber, and taking a mean value from the measurements. In such cases, polarization mode dispersion can be calculated based on the following equations:

$$Δτ = {D}_{PMD} \sqrt{L} , \qquad ( Eqn . 6 )$$

$${D}_{PMD} = \frac{Δ τ}{\sqrt{L}} , \qquad ( Eqn . 7 )$$

where λτ is a mean polarization-dependent time-differential, D_{PMD} is the polarization mode dispersion parameter of the HCF, and L is the length of the HCF.

In some examples, over the lifetime of an optical network line system, the original fiber span (e.g., a 50 km span that is laid out on day one) can change due to infrastructure changes that are performed near or around the fiber that is laid out. For example, two years after day one, a road is built over the fiber span that necessitates rerouting of the fiber, so additional fiber (e.g., an additional 700 meters (m)) is spliced onto the original fiber span. Some years after that, further changes are made, and either more lengths of fiber are added or some of the length of fiber is removed. To determine the actual length of the fiber at any one time, the time delay for each of the OSC signals, which are transmitted at different wavelengths, can be used to calculate the actual length, in some cases, based on the chromatic dispersion calculations based on Eqns. 3-5 above. In some instances, historical measurements, which may be stored in a database (e.g., database 185a, 185b, and/or 185 of FIG. 1), can be used to compare with current measurements to further refine the calculation of actual current fiber length.

In examples, an operational status of an optical amplifier in the optical network line system can be determined by using an OSC signal that is multiplexed before an optical amplifier (e.g., OSC signal at wavelength λ₄ that is generated by OSC system 155d and that is injected prior to booster amplifier 145a via optical coupler 160 in FIG. 1). In some cases, the results of the measured OSC signal at the receiving transponder (e.g., by OSC system 155h in second transponder 105b in FIG. 1) can be compared with results of the measured OSC signals at the other wavelengths (e.g., OSC signals at wavelengths λ₁-λ₃ that are generated by OSC systems 155a-155c and that are injected after the booster amplifier 145a via optical couplers 160, then measured by OSC systems 155e-155g in transponder 105b in FIG. 1). Irregularities with the operation of the booster amplifier can be determined based on the comparison. In some cases, historical measurements and/or comparison results, which may also be stored in the database, can be used to compare with current results to further determine whether there are issues with the optical amplifier.

FIG. 4 depicts an example method 400 for implementing an HCF-based optical network line system with multiple multiplexed optical supervisory channels. In examples, the operations of example method 400 may be performed by a first transponder and/or a second transponder (e.g., first transponder 105a and/or second transponder 105b of FIG. 1), by components thereof (e.g., controller 120a and/or controller 120b of FIG. 1), and/or by a computing system (e.g., computing system 125, 125a, and/or 125b of FIG. 1).

In the example method 400 of FIG. 4, at operation 405, includes a first transponder (e.g., first transponder 105a of FIG. 1) receiving a first optical data signal at a first signal wavelength (e.g., λ_{S1}; or first signal wavelength range). In some examples, the first transponder is located at a first location. At operation 410, the first transponder amplifies, using an optical amplifier of the first transponder (e.g., booster amplifier 145a of FIG. 1), the first optical data signal into a second optical data signal. At operation 415, the first transponder generates, using two or more OSC transmitters of the first transponder (e.g., OSC systems 155a-155d of FIG. 1), two or more OSC signals at corresponding two or more OSC wavelengths (e.g., λ₁-λ₄ of FIG. 1) that are separate from the first signal wavelength range. In examples, the two or more OSC signals carry data signals corresponding to diagnostic data associated with transmission of the optical data signal. In examples, the first signal wavelength or first signal wavelength range lies within one of the 850 nm Band, the O-Band, the E-Band, the S-Band, the C-Band, the L-Band, or the U-Band, while each of the two or more OSC signals lie within another of the 850 nm Band, the O-Band, the E-Band, the S-Band, the C-Band, the L-Band, or the U-Band.

At operation 420, the first transponder injects each of the two or more OSC signals in the second optical data signal, in some cases, via WDM, using a corresponding optical coupler among two or more optical couplers (e.g., optical couplers 160 of the FIG. 1). At operation 425, the first transponder transmits the second optical data signal, with the injected two or more OSC signals, to a second transponder (e.g., second transponder 105b of FIG. 1) over at least one HCF cable (e.g., HCF or HCF cable 165a of FIG. 1) communicatively coupling the second transponder to the first transponder over a first fiber path distance (e.g., distance d of FIG. 1).

In some examples, the distance d is one of about 50 km, about 60 km, about 70 km, about 80 km, about 90 km, about 100 km, about 110 km, about 120 km, about 130 km, about 140 km, about 150 km, about 175 km, about 200 km, about 225 km, about 250 km, about 275 km, about 300 km, about 325 km, about 350 km, about 375 km, about 400 km, about 425 km, about 450 km, about 475 km, about 500 km, about 550 km, about 600 km, about 650 km, about 700 km, about 750 km, about 800 km, about 850 km, about 900 km, about 950 km, about 1000 km, or greater. In some examples, the distance d ranges from about 15 km to about 60 km, from about 50 km to about 120 km, from about 60 km to about 120 km, from about 100 km to about 1000 km, or greater. In examples, the first transponder and the second transponder are part of an optical network line system.

At operation 430, the second transponder receives the second optical data signal, with the injected two or more OSC signals, from the first transponder. The second transponder is located at a second location that is geographically separated from the first location. At operation 435, the second transponder extracts each of the two or more OSC signals from the second optical data signal, in some cases, using a filter for a corresponding OSC wavelength among the two or more OSC wavelengths. At operation 440, the second transponder detects, using two or more OSC signal detectors of the second transponder (e.g., OSC systems 155e-155h of FIG. 1), the two or more OSC signals extracted from the second optical data signal. At operation 445, a computing system (e.g., computing system 125, 125a, and/or 125b of FIG. 1) analyzes the two or more OSC signals detected by the two or more OSC signal detectors. At operation 450, the computing system performs at least one of: (a) determining whether the two or more OSC signals indicate potential issues in the optical network line system based on the analysis (at operation 455); or (b) measuring one or more optical properties of the optical network line system (at operation 460).

In some example, the potential issues in the optical network line system include at least one of gas ingress, a fiber cut, a fiber bend, a fiber pinch, or a fiber constriction in an HCF of the at least one HCF cable. In an example, a potential issue involving gas ingress in the HCF of the at least one HCF cable is identified when a first OSC signal detector, among the two or more OSC signal detectors, that is calibrated to receive first OSC signals at a first wavelength corresponding to a wavelength absorption of a first gas detects signal degradation in the first OSC signals at the first wavelength. Meanwhile a second OSC signal detector, among the two or more OSC signal detectors, that is calibrated to receive second OSC signals at a second wavelength, which is different from the first wavelength, detects no change in the second OSC signals at the second wavelength. In another example, a potential issue involving a fiber cut in the HCF of the at least one HCF cable that is identified when the two or more OSC signal detectors that are calibrated to receive corresponding two or more OSC signals at corresponding two or more different wavelengths simultaneously detect signal losses. In yet another example, a potential issue involving one of the fiber bend, the fiber pinch, or the fiber constriction in the HCF of the at least one HCF cable is identified when the two or more OSC signal detectors that are calibrated to receive corresponding two or more OSC signals at corresponding two or more different wavelengths detect signal degradation at staggered intervals. In such a case, OSC signals having shorter wavelengths show greater signal degradation compared with OSC signals having longer wavelengths, with OSC signals having shorter wavelengths showing signal degradation before signal degradation of OSC signals having longer wavelengths.

In examples, the one or more optical properties of the optical network line system include at least one of chromatic dispersion or polarization mode dispersion. In some examples, the two or more OSC signals include a third OSC signal at a third wavelength, a fourth OSC signal at a fourth wavelength, and a fifth OSC signal at a fifth wavelength, the fourth wavelength being longer than the third wavelength, and the fifth wavelength being longer than the fourth wavelength. In some cases, measuring the chromatic dispersion of the optical network line system includes calculating an overall ratio of a first SNR to a second SNR, where the first SNR is calculated based on a difference between the fourth wavelength and the third wavelength, while the second SNR is calculated based on a difference between the fifth wavelength and the third wavelength. In some instances, the first SNR and the second SNR are further calculated based on an estimated dispersion value per a set wavelength interval for an HCF. In examples, the first transponder further includes two or more polarizers coupled to outputs of at least two OSC transmitters, among two or more OSC transmitters, that cause at least two OSC signals, among the two or more OSC signals, to have different polarizations. In such cases, measuring the one or more optical properties includes measuring the polarization mode dispersion of the optical network line system, by calculating a mean polarization-dependent time-differential value for the at least two OSC signals that have different polarizations.

In some instances, the one or more potential issues in the optical network line system further include amplifier issues with an optical amplifier that that is used to amplify optical data signals prior to transmission as the optical data traffic over the at least one HCF cable to the second transponder. Amplifier issues may be identified when gain attenuation of an OSC signal at an OSC wavelength that is amplified by the optical amplifier is compared with gain attenuation of the optical data signals, which are transmitted at a signal wavelength that is different from the OSC wavelength. If the gain attenuation of the OSC signal at the OSC wavelength does not match an expected gain attenuation, then an issue with the amplifier may be flagged.

In some cases, at least one of the two or more OSC transmitters includes a tunable laser, where generating the two or more OSC signals includes:
(1) the first transponder tuning the tunable laser to produce a first OSC signal at a first selectable wavelength at a first instance;
(2) the first transponder generating, using the tunable laser, the first OSC signal at the first selectable wavelength based on the tuning;
(3) the first transponder tuning the tunable laser to produce a second OSC signal at a second selectable wavelength at a second instance, the second selectable wavelength being different from the first selectable wavelength; and
(4) the first transponder generating, using the tunable laser, the second OSC signal at the second selectable wavelength based on the tuning.

In some examples, the OSC signals detected by the two or more OSC signal detectors correspond to the two or more OSC signals transmitted by the first transponder, where the first transponder transmits the two or more OSC signals at periodic intervals. In examples, the computing system stores the OSC signals detected by the two or more OSC signal detectors at the periodic intervals in a datastore as a lifetime operational record corresponding to the at least one HCF cable. In some instances, time delays of the two or more OSC signals at the corresponding two or more OSC wavelengths at different lifetime periods as recorded in the datastore are used to measure changes in the first fiber path distance of the at least one HCF cable over a lifetime of the at least one HCF cable due to infrastructure changes of the optical network line system.

While the techniques and procedures in method 400 is depicted and/or described in a certain order for purposes of illustration, it should be appreciated that certain procedures may be reordered and/or omitted within the scope of various embodiments. Moreover, while the method 400 may be implemented by or with (and, in some cases, are described below with respect to) the systems, examples, or embodiments 100, 200A-200D, and 300A-300D of FIGS. 1, 2A-2D, and 3A-3D, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the method 400 (e.g., by executing instructions embodied on a computer readable medium), the systems, examples, or embodiments 100, 200A-200D, and 300A-300D of FIGS. 1, 2A-2D, and 3A-3D can each also operate according to other modes of operation and/or perform other suitable procedures.

As should be appreciated from the foregoing, the present technology provides multiple technical benefits and solutions to technical problems. For instance, providing an optical network line system, particularly over an SCF-based line system generally raises multiple technical problems. For example, in SCF-based optical network line systems, additional OSCs cannot be sustained because the increased signal power from another OSC light source can cause the optical network line system to experience optical nonlinearities, which adversely affects signals transmitted over the SCF (e.g., data signal transmissions as well as OSC signal transmissions). Where there is only a single OSC channel, a drop in OSC signal power could be due to a fiber break, a fiber bend, an imperfect connection, amongst other potential causes, without clarity on which potential cause is more likely to be the actual cause. The present technology provides for an HCF-based optical network line system with multiple multiplexed optical supervisory channels. Because HCFs are capable of high optical power transmissions without incurring non-linearities, HCF-based optical network line systems can be configured to include multiple OSC transmitters whose OSC signals can be multiplexed with the optical data signals. The multiple OSC signals allow for detecting and identifying potential causes. In some examples, with multiple OSC channels, one could utilize the ratio of power drop between the various wavelengths to determine a source of the degradation. In this manner, the use of multiple OSC signals enhances reliability, while reducing rates, of the optical network line system due to the identification of the potential causes of issues based on analyses of the multiple OSC signals (at the various different OSC wavelengths), which enables targeted repair of faults in the optical network line system, thereby significantly reducing the time to repair such faults. Accordingly, the optical network line system can remain fully operational, while working optimally.

In an aspect, the technology relates to a hollow core fiber-based optical network line system with multiple multiplexed OSCs. The hollow core fiber-based optical network line system includes a first transponder located at a first location, a second transponder located at a second location that is geographically separated from the first location, and at least one HCF cable communicatively coupling the second transponder to the first transponder over a first fiber path distance. The first transponder transmits optical data traffic at a first signal wavelength range and transmits two or more OSC signals at corresponding two or more OSC wavelengths. The two or more OSC signals carry data signals corresponding to diagnostic data associated with transmission of the optical data traffic. The at least one HCF cable carries the optical data traffic and the two or more OSC signals between the first and second transponders. The hollow core fiber-based optical network line system further includes a plurality of OSC signal detectors disposed within at least one of the first transponder or the second transponder. Each of the plurality of OSC signal detectors detects OSC signals at one of the corresponding two or more OSC wavelengths. The hollow core fiber-based optical network line system further includes a computing system that receives and analyzes OSC signals detected by two or more OSC signal detectors among the plurality of OSC signal detectors, that identifies one or more potential issues in the optical network line system based on the analysis of the OSC signals, and that measures one or more optical properties of the optical network line system.

In some examples, the one or more potential issues in the optical network line system include at least one of gas ingress, a fiber cut, a fiber bend, a fiber pinch, or a fiber constriction in an HCF of the at least one HCF cable. In some cases, the one or more potential issues involves the gas ingress in the HCF of the at least one HCF cable that is identified when a first OSC signal detector, among the two or more OSC signal detectors, that is calibrated to receive first OSC signals at a first wavelength corresponding to a wavelength absorption of a first gas detects signal degradation in the first OSC signals at the first wavelength, while a second OSC signal detector, among the two or more OSC signal detectors, that is calibrated to receive second OSC signals at a second wavelength, which is different from the first wavelength, detects no change in the second OSC signals at the second wavelength.

Alternatively, the one or more potential issues involves the fiber cut in the HCF of the at least one HCF cable that is identified when the two or more OSC signal detectors that are calibrated to receive corresponding two or more OSC signals at corresponding two or more different wavelengths simultaneously detect signal losses. Alternatively, the one or more potential issues involves one of the fiber bend, the fiber pinch, or the fiber constriction in the HCF of the at least one HCF cable that is identified when the two or more OSC signal detectors that are calibrated to receive corresponding two or more OSC signals at corresponding two or more different wavelengths detect signal degradation at staggered intervals, with OSC signals having shorter wavelengths showing greater signal degradation compared with OSC signals having longer wavelengths, and with OSC signals having shorter wavelengths showing signal degradation before signal degradation of OSC signals having longer wavelengths.

In examples, the first transponder includes an optical amplifier that amplifies optical data signals prior to transmission as the optical data traffic over the at least one HCF cable to the second transponder. The one or more potential issues in the optical network line system further include amplifier issues with the optical amplifier that are identified when gain attenuation of an OSC signal at an OSC wavelength that is amplified by the optical amplifier is compared with gain attenuation of the optical data signals, which are transmitted at a signal wavelength that is different from the OSC wavelength.

In some examples, the first transponder includes two or more OSC transmitters, at least one of which includes a tunable laser that transmits an OSC at selectable wavelengths. In some cases, each of the two or more OSC transmitters injects a corresponding one of the two or more OSC signals in the optical data traffic via wavelength division multiplexing, using an optical coupler. In some instances, the one or more optical properties of the optical network line system include at least one of chromatic dispersion or polarization mode dispersion. In examples, the two or more OSC signals include a third OSC signal at a third wavelength, a fourth OSC signal at a fourth wavelength, and a fifth OSC signal at a fifth wavelength, the fourth wavelength being longer than the third wavelength, and the fifth wavelength being longer than the fourth wavelength. In some cases, measuring the one or more optical properties includes measuring the chromatic dispersion of the optical network line system, by calculating an overall ratio of a first SNR to a second SNR. In some instances, the first SNR is calculated based on a difference between the fourth wavelength and the third wavelength, while the second SNR is calculated based on a difference between the fifth wavelength and the third wavelength. In some examples, the first SNR and the second SNR are further calculated based on an estimated dispersion value per a set wavelength interval for an HCF. In examples, the first transponder further includes two or more polarizers coupled to outputs of at least two OSC transmitters, among the two or more OSC transmitters, that cause at least two OSC signals, among the two or more OSC signals, to have different polarizations. In some instances, measuring the one or more optical properties includes measuring the polarization mode dispersion of the optical network line system, by calculating a mean polarization-dependent time-differential value for the at least two OSC signals that have different polarizations.

In examples, the OSC signals detected by the two or more OSC signal detectors correspond to the two or more OSC signals transmitted by the first transponder. In some cases, the first transponder transmits the two or more OSC signals at periodic intervals. The computing system stores the OSC signals detected by the two or more OSC signal detectors at the periodic intervals in a datastore as a lifetime operational record corresponding to the at least one HCF cable. In some instances, time delays of the two or more OSC signals at the corresponding two or more OSC wavelengths at different lifetime periods as recorded in the datastore are used to measure changes in the first fiber path distance of the at least one HCF cable over a lifetime of the at least one HCF cable due to infrastructure changes of the optical network line system.

In another aspect, the technology relates to a computer-implemented method for implementing a hollow core fiber-based optical network line system with multiple multiplexed OSCs. The method includes receiving, by a first transponder of an optical network line system, a first optical data signal at a first signal wavelength range, the first transponder being located at a first location. The method also includes amplifying, by the first transponder and using an optical amplifier of the first transponder, the first optical data signal into a second optical data signal. The method further includes generating, by the first transponder and using two or more OSC transmitters of the first transponder, two or more OSC signals at corresponding two or more OSC wavelengths that are separate from the first signal wavelength range. The two or more OSC signals carry data signals corresponding to diagnostic data associated with transmission of the second optical data signal. The method further includes injecting, by the first transponder, each of the two or more OSC signals in the second optical data signal. The method further includes transmitting, by the first transponder, the second optical data signal, with the injected two or more OSC signals, to a second transponder over at least one HCF cable communicatively coupling the second transponder to the first transponder over a first fiber path distance.

In some examples, the method further includes receiving, by the second transponder, the second optical data signal, with the injected two or more OSC signals, from the first transponder, the second transponder being located at a second location that is geographically separated from the first location. The method further includes extracting, by the second transponder, each of the two or more OSC signals from the second optical data signal, using a filter for a corresponding OSC wavelength among the two or more OSC wavelengths. The method further includes detecting, by the second transponder and using two or more OSC signal detectors of the second transponder, the two or more OSC signals extracted from the second optical data signal. The method further includes analyzing, by a computing system, the two or more OSC signals detected by the two or more OSC signal detectors. The method further includes performing, by the computing system, at least one of: determining whether the two or more OSC signals indicate potential issues in the optical network line system based on the analysis; or measuring one or more optical properties of the optical network line system.

In examples, the potential issues in the optical network line system include at least one of gas ingress, a fiber cut, a fiber bend, a fiber pinch, or a fiber constriction in an HCF of the at least one HCF cable. In some cases, the one or more optical properties of the optical network line system include at least one of chromatic dispersion or polarization mode dispersion. In examples, at least one of the two or more OSC transmitters includes a tunable laser. In some instances, generating the two or more OSC signals includes: tuning, by the first transponder, the tunable laser to produce a first OSC signal at a first selectable wavelength at a first instance; generating, by the first transponder and using the tunable laser, the first OSC signal at the first selectable wavelength based on the tuning; tuning, by the first transponder, the tunable laser to produce a second OSC signal at a second selectable wavelength at a second instance, the second selectable wavelength being different from the first selectable wavelength; and generating, by the first transponder and using the tunable laser, the second OSC signal at the second selectable wavelength based on the tuning.

In yet another aspect, the technology relates to a computer-implemented method for implementing a hollow core fiber-based optical network line system with multiple multiplexed OSCs. The method includes receiving, by a second transponder and from a first transponder of an optical network line system, an optical data signal, with two or more OSC signals injected in the optical data signal, over at least one HCF cable communicatively coupling the second transponder to the first transponder over a first fiber path distance. The optical data signal is transmitted at a first signal wavelength range and the two or more OSC signals are transmitted at corresponding two or more OSC wavelengths that are separate from the first signal wavelength range. The method further includes extracting, by the second transponder, each of the two or more OSC signals from the optical data signal, using a filter for a corresponding OSC wavelength among the two or more OSC wavelengths. The method further includes detecting, by the second transponder and using two or more OSC signal detectors of the second transponder, the two or more OSC signals extracted from the optical data signal; and analyzing, by a computing system, the two or more OSC signals detected by the two or more OSC signal detectors. The method further includes performing, by the computing system, at least one of: determining whether the two or more OSC signals indicate potential issues in the optical network line system based on the analysis; or measuring one or more optical properties of the optical network line system.

In some examples, the potential issues in the optical network line system include at least one of gas ingress, a fiber cut, a fiber bend, a fiber pinch, or a fiber constriction in an HCF of the at least one HCF cable. In some cases, the one or more optical properties of the optical network line system include at least one of chromatic dispersion or polarization mode dispersion. In some instances, the two or more OSC signals are transmitted from the first transponder at periodic intervals, and the method further includes storing, by the computing system and in a datastore, the two or more OSC signals detected by the two or more OSC signal detectors at the periodic intervals as a lifetime operational record corresponding to the at least one HCF cable.

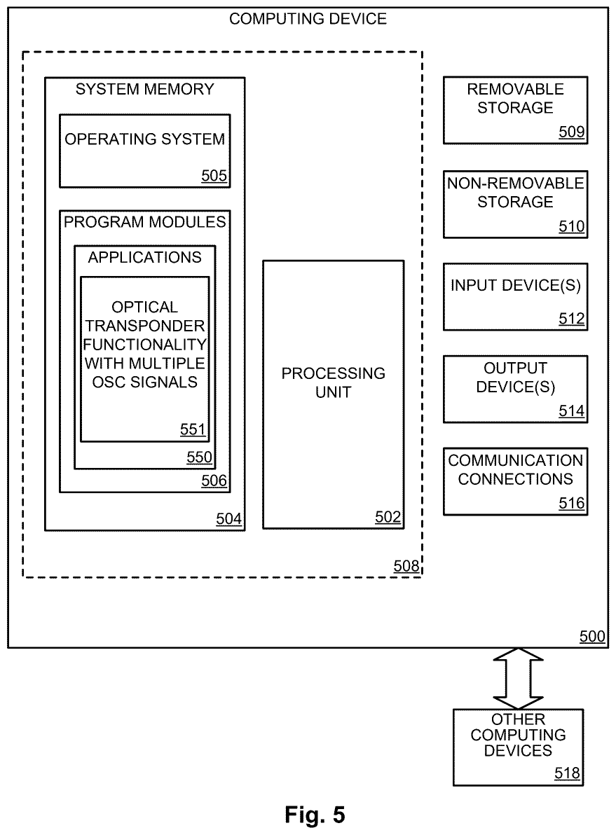

FIG. 5 depicts a block diagram illustrating physical components (i.e., hardware) of a computing device 500 with which examples of the present disclosure may be practiced. The computing device components described below may be suitable for a client device implementing the HCF-based optical network line system with multiple multiplexed optical supervisory channels, as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as optical transponder functionality with multiple OSC signals 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIG. 4, or one or more operations of the system(s) and/or apparatus(es) as described with respect to FIGS. 1-3D, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A hollow core fiber-based optical network line system with multiple multiplexed optical supervisory channels (“OSCs”), the hollow core fiber-based optical network line system comprising:
a first transponder located at a first location, the first transponder transmitting optical data traffic at a first signal wavelength range and transmitting two or more OSC signals at corresponding two or more OSC wavelengths, the two or more OSC signals carrying data signals corresponding to diagnostic data associated with transmission of the optical data traffic;
a second transponder located at a second location that is geographically separated from the first location;
at least one hollow core fiber (“HCF”) cable communicatively coupling the second transponder to the first transponder over a first fiber path distance, the at least one HCF cable carrying the optical data traffic and the two or more OSC signals between the first and second transponders;
a plurality of OSC signal detectors disposed within at least one of the first transponder or the second transponder, each of the plurality of OSC signal detectors detecting OSC signals at one of the corresponding two or more OSC wavelengths; and
a computing system that receives and analyzes OSC signals detected by two or more OSC signal detectors among the plurality of OSC signal detectors, that identifies one or more potential issues in the optical network line system based on the analysis of the OSC signals, and that measures one or more optical properties of the optical network line system.

2. The hollow core fiber-based optical network line system of claim 1, wherein the one or more potential issues in the optical network line system include at least one of gas ingress, a fiber cut, a fiber bend, a fiber pinch, or a fiber constriction in an HCF of the at least one HCF cable.

3. The hollow core fiber-based optical network line system of claim 2, wherein the one or more potential issues involves the gas ingress in the HCF of the at least one HCF cable that is identified when a first OSC signal detector, among the two or more OSC signal detectors, that is calibrated to receive first OSC signals at a first wavelength corresponding to a wavelength absorption of a first gas detects signal degradation in the first OSC signals at the first wavelength, while a second OSC signal detector, among the two or more OSC signal detectors, that is calibrated to receive second OSC signals at a second wavelength, which is different from the first wavelength, detects no change in the second OSC signals at the second wavelength.

4. The hollow core fiber-based optical network line system of claim 2, wherein the one or more potential issues involves the fiber cut in the HCF of the at least one HCF cable that is identified when the two or more OSC signal detectors that are calibrated to receive corresponding two or more OSC signals at corresponding two or more different wavelengths simultaneously detect signal losses.

5. The hollow core fiber-based optical network line system of claim 2, wherein the one or more potential issues involves one of the fiber bend, the fiber pinch, or the fiber constriction in the HCF of the at least one HCF cable that is identified when the two or more OSC signal detectors that are calibrated to receive corresponding two or more OSC signals at corresponding two or more different wavelengths detect signal degradation at staggered intervals, with OSC signals having shorter wavelengths showing greater signal degradation compared with OSC signals having longer wavelengths, and with OSC signals having shorter wavelengths showing signal degradation before signal degradation of OSC signals having longer wavelengths.

6. The hollow core fiber-based optical network line system of claim 1, wherein the first transponder comprises an optical amplifier that amplifies optical data signals prior to transmission as the optical data traffic over the at least one HCF cable to the second transponder, wherein the one or more potential issues in the optical network line system further include amplifier issues with the optical amplifier that are identified when gain attenuation of an OSC signal at an OSC wavelength that is amplified by the optical amplifier is compared with gain attenuation of the optical data signals, which are transmitted at a signal wavelength that is different from the OSC wavelength.

7. The hollow core fiber-based optical network line system of claim 1, wherein the first transponder comprises two or more OSC transmitters, at least one of which includes a tunable laser that transmits an OSC at selectable wavelengths.

8. The hollow core fiber-based optical network line system of claim 7, wherein each of the two or more OSC transmitters injects a corresponding one of the two or more OSC signals in the optical data traffic via wavelength division multiplexing, using an optical coupler.

9. The hollow core fiber-based optical network line system of claim 7, wherein the one or more optical properties of the optical network line system include at least one of chromatic dispersion or polarization mode dispersion.

10. The hollow core fiber-based optical network line system of claim 9, wherein the two or more OSC signals include a third OSC signal at a third wavelength, a fourth OSC signal at a fourth wavelength, and a fifth OSC signal at a fifth wavelength, the fourth wavelength being longer than the third wavelength, and the fifth wavelength being longer than the fourth wavelength, wherein measuring the one or more optical properties includes measuring the chromatic dispersion of the optical network line system, by calculating an overall ratio of a first signal-to-noise ratio (“SNR”) to a second SNR, wherein the first SNR is calculated based on a difference between the fourth wavelength and the third wavelength, while the second SNR is calculated based on a difference between the fifth wavelength and the third wavelength, wherein the first SNR and the second SNR are further calculated based on an estimated dispersion value per a set wavelength interval for an HCF.

11. The hollow core fiber-based optical network line system of claim 9, wherein the first transponder further comprises two or more polarizers coupled to outputs of at least two OSC transmitters, among the two or more OSC transmitters, that cause at least two OSC signals, among the two or more OSC signals, to have different polarizations, wherein measuring the one or more optical properties includes measuring the polarization mode dispersion of the optical network line system, by calculating a mean polarization-dependent time-differential value for the at least two OSC signals that have different polarizations.

12. The hollow core fiber-based optical network line system of claim 1, wherein the OSC signals detected by the two or more OSC signal detectors correspond to the two or more OSC signals transmitted by the first transponder, wherein the first transponder transmits the two or more OSC signals at periodic intervals, wherein the computing system stores the OSC signals detected by the two or more OSC signal detectors at the periodic intervals in a datastore as a lifetime operational record corresponding to the at least one HCF cable.

13. The hollow core fiber-based optical network line system of claim 12, wherein time delays of the two or more OSC signals at the corresponding two or more OSC wavelengths at different lifetime periods as recorded in the datastore are used to measure changes in the first fiber path distance of the at least one HCF cable over a lifetime of the at least one HCF cable due to infrastructure changes of the optical network line system.

14. A computer-implemented method for implementing a hollow core fiber-based optical network line system with multiple multiplexed optical supervisory channels (“OSCs”), the method comprising:
receiving, by a first transponder of an optical network line system, a first optical data signal at a first signal wavelength range, the first transponder being located at a first location;
amplifying, by the first transponder and using an optical amplifier of the first transponder, the first optical data signal into a second optical data signal;
generating, by the first transponder and using two or more OSC transmitters of the first transponder, two or more OSC signals at corresponding two or more OSC wavelengths that are separate from the first signal wavelength range, the two or more OSC signals carrying data signals corresponding to diagnostic data associated with transmission of the second optical data signal;
injecting, by the first transponder, each of the two or more OSC signals in the second optical data signal; and
transmitting, by the first transponder, the second optical data signal, with the injected two or more OSC signals, to a second transponder over at least one hollow core fiber (“HCF”) cable communicatively coupling the second transponder to the first transponder over a first fiber path distance.

15. The computer-implemented method of claim 14, further comprising:
receiving, by the second transponder, the second optical data signal, with the injected two or more OSC signals, from the first transponder, the second transponder being located at a second location that is geographically separated from the first location;
extracting, by the second transponder, each of the two or more OSC signals from the second optical data signal, using a filter for a corresponding OSC wavelength among the two or more OSC wavelengths;
detecting, by the second transponder and using two or more OSC signal detectors of the second transponder, the two or more OSC signals extracted from the second optical data signal;
analyzing, by a computing system, the two or more OSC signals detected by the two or more OSC signal detectors; and
performing, by the computing system, at least one of:
determining whether the two or more OSC signals indicate potential issues in the optical network line system based on the analysis; or
measuring one or more optical properties of the optical network line system.

16. The computer-implemented method of claim 15, wherein the potential issues in the optical network line system include at least one of gas ingress, a fiber cut, a fiber bend, a fiber pinch, or a fiber constriction in an HCF of the at least one HCF cable, wherein the one or more optical properties of the optical network line system include at least one of chromatic dispersion or polarization mode dispersion.

17. The computer-implemented method of claim 14, wherein at least one of the two or more OSC transmitters includes a tunable laser, wherein generating the two or more OSC signals comprises:
tuning, by the first transponder, the tunable laser to produce a first OSC signal at a first selectable wavelength at a first instance;
generating, by the first transponder and using the tunable laser, the first OSC signal at the first selectable wavelength based on the tuning;
tuning, by the first transponder, the tunable laser to produce a second OSC signal at a second selectable wavelength at a second instance, the second selectable wavelength being different from the first selectable wavelength; and
generating, by the first transponder and using the tunable laser, the second OSC signal at the second selectable wavelength based on the tuning.

18. A computer-implemented method for implementing a hollow core fiber-based optical network line system with multiple multiplexed optical supervisory channels (“OSCs”), the method comprising:
receiving, by a second transponder and from a first transponder of an optical network line system, an optical data signal, with two or more OSC signals injected in the optical data signal, over at least one hollow core fiber (“HCF”) cable communicatively coupling the second transponder to the first transponder over a first fiber path distance, the optical data signal being transmitted at a first signal wavelength range and the two or more OSC signals being transmitted at corresponding two or more OSC wavelengths that are separate from the first signal wavelength range;
extracting, by the second transponder, each of the two or more OSC signals from the optical data signal, using a filter for a corresponding OSC wavelength among the two or more OSC wavelengths;
detecting, by the second transponder and using two or more OSC signal detectors of the second transponder, the two or more OSC signals extracted from the optical data signal;
analyzing, by a computing system, the two or more OSC signals detected by the two or more OSC signal detectors; and
performing, by the computing system, at least one of:
determining whether the two or more OSC signals indicate potential issues in the optical network line system based on the analysis; or
measuring one or more optical properties of the optical network line system.

19. The computer-implemented method of claim 18, wherein the potential issues in the optical network line system include at least one of gas ingress, a fiber cut, a fiber bend, a fiber pinch, or a fiber constriction in an HCF of the at least one HCF cable, wherein the one or more optical properties of the optical network line system include at least one of chromatic dispersion or polarization mode dispersion.

20. The computer-implemented method of claim 18, wherein the two or more OSC signals are transmitted from the first transponder at periodic intervals, wherein the method further comprises:
storing, by the computing system and in a datastore, the two or more OSC signals detected by the two or more OSC signal detectors at the periodic intervals as a lifetime operational record corresponding to the at least one HCF cable.
